(19) United States
(12) Patent Application Publication
(10) Pub. No.: US 2012/0206636 A1
(43) Pub. Date: Aug. 16, 2012

(54) ADJUSTER FOR ADJUSTING THE DIRECTION OF A LIGHT BEAM AND OPTICAL DEVICE COMPRISING SUCH ADJUSTER

(75) Inventors: Fetze Pijlman, Eindhoven (NL); Marcellinus Petrus Carolus Michael Krijn, Eindhoven (NL)

(73) Assignee: KONINKLIJKE PHILIPS ELECTRONICS, N.V., EINDHOVEN (NL)

(21) Appl. No.: 13/500,951

(22) PCT Filed: Sep. 30, 2010
(86) PCT No.: PCT/IB10/54411

§ 371 Date: Apr. 9, 2012

(30) Foreign Application Priority Data
Oct. 30, 2009 (EP) 09174563.8

(51) Int. Cl. H04N 5/335; H04N 5/225; G02F 1/29

(52) U.S. Cl. 348/311; 359/298; 349/196; 348/370; 348/E05.091; 348/E05.029

(57) ABSTRACT

The invention provides an adjuster for adjusting the direction of a light beam (5). The adjuster (1) has an off-state and an on-state and comprises a stack (10) of layers. The stack (10) comprises a first solid material layer (100) having a first optic axis (111), a second solid material layer (200) having a second optic axis (211), and switchable birefringent material (30). Further, the stack includes a first interface (130) between the first solid material layer (100) and birefringent material (30) and a second interface (230) between the second solid material layer (200) and birefringent material (30). In the off-state, the birefringent material (30) at the first interface (130) is configured to have an optic axis parallel to the first optic axis (111) and the birefringent material (30) at the second interface (230) is configured to have an optic axis parallel to the second optic axis (211). In the on-state, the birefringent material (30) at the first interface (130) is configured to have an optic axis perpendicular to the first optic axis (111), and the birefringent material (30) at the second interface (230) is configured to have an optic axis perpendicular to the second optic axis (211). This device may be used to redirect light beams, for instance for spotlights, display devices or optical sensors.

### FIELD OF THE INVENTION

The invention relates to an adjuster for adjusting the direction of a light beam. The invention further relates to an optical device, such as a spotlight or display, comprising a light source, configured to generate a beam of light, and such an adjuster. The invention also relates to an optical device, such as a CCD camera.

### BACKGROUND OF THE INVENTION

WO/2008/095627 describes a lighting apparatus provided with a light source formed by means of a plurality of LED-type light emitters capable of generating single light beams which are optically directed by means of lenses mounted on a shaped base in respective planes of lie so as to produce an overall beam of light with an orientation defined by the direction of said individual beams and by the lie of the emitters.

WO/2009/059465 describes a lighting system comprising a plurality of light units, wherein said light units are arranged in an array, wherein the light beams of substantially each pair of adjacent light units overlap each other, and wherein the light system comprises a light control means which is arranged to adjust the intensity of each one of said plurality of light units individually, wherein said light control means is further arranged to maintain the total combined luminous flux of said plurality of light units incident on a predefined imaginary flat surface substantially equal when adapting the intensity of the individual light units.

WO/2008/047381 relates to a headlamp assembly and more particularly to a motorized headlamp leveling device used to adjust the position of headlamps of vehicles/automobiles or other similar applications such as watchtowers, wherein the light beam is directed in the required direction. It is adapted to be driven by motor and worm/gear assembly means and controlled by an electronic circuit. The actuator mechanism comprises an adjuster output shaft extending from the housing and a control unit for controlling the drive of the motor. There is a sealing member adapted for said adjuster output shaft to seal with said housing and said housing is adapted to seal with the housing of the headlamp assembly.

WO/2007/082102 describes an optical device and a method of varying an optical characteristic of an optical beam, and said optical device can include a plurality of optical fibers, each having an input end, an output end, and a core, wherein each of the optical fibers has an effective area and a numerical aperture, and a beam deviating component for moving at least one of the optical fiber input ends and the optical beam relative to each other such that each one of the optical beams selectively enters the input ends one at a time and is transmitted out of the output ends one at a time, wherein at least one of the effective areas and the numerical apertures varies among the plurality of optical fibers such that the optical beam transmitted out of the output ends has a varying optical characteristic.

### SUMMARY OF THE INVENTION

The invention especially relates to optical devices, such as displays or spotlights. Spotlights are found in homes, hotels, theatres, headlights of cars, etc. Their collimated light enables efficient illumination of certain areas, giving often also a large contrast with the adjacent environment. Since a spotlight produces collimated light, the spotlight needs to be directed. In some applications it is desired that this adjustment of the spotlight can be done from a remote distance (like in the case of cars). A common solution to this desire is the use of a motor that changes the direction of the spotlight.

For some applications, the use of motors for adjusting the direction of the spotlight is less preferred. The use of motors can for instance introduce noise, or the motors may need maintenance over time. This may become an issue for LED spotlights because the lifetime of the motor determines the lifetime of the spotlights. Other options include a plurality of light sources, wherein the individual light sources are addressed.

A disadvantage of prior art solutions may be the complexity of the systems, the generation of noise, the need to use polarized light, etc.

It is an object of the invention to provide an alternative adjuster that preferably at least partly obviates one or more of the described drawbacks. A further object of the invention is to enable unpolarized light to be redirected or reshaped by means of non-mechanical moving parts, using materials that are available today. Further, it is an object of the invention to propose optical devices comprising such alternative adjuster(s).

Here, it is proposed to provide an adjuster based on ordinary liquid crystals (LCs) that are readily available today. Such LC material is considered a switchable birefingent material. In addition to this, fixed birefringent microstructures are applied. The combination of these two materials may provide an adjuster without moving parts, that may nevertheless be able to adjust/move the light beam of a light source.

In a first aspect, the invention provides an adjuster for adjusting the direction of a light beam, the adjuster having an off-state and an on-state and comprising a stack of layers, wherein
a. the stack comprises a first solid material layer having a first optic axis, a second solid material layer having a second optic axis, and switchable birefringent material;
b. a first interface between the first solid material layer and birefringent material and a second interface between the second solid material layer and birefringent material; wherein
in the off-state, the birefringent material at the first interface is configured to have an optic axis parallel to the first optic axis and the birefringent material at the second interface is configured to have an optic axis parallel to the second optic axis; and
in the on-state, the birefringent material at the first interface is configured to have an optic axis perpendicular to the first optic axis and the birefringent material at the second interface is configured to have an optic axis perpendicular to the second optic axis.

Hence, the adjuster is configured to be able to adjust the direction of the beam of light (“light beam” or “beam”) generated by a light source. Such an adjuster can be arranged to for instance a spotlight or a display device (see also below). In general, the adjuster is arranged to intercept the beam of light (when the light source is switched on). In at least one of the states, the adjuster is at least partially transmissive to at least part of the light generated by the light source to which the adjuster is arranged. Preferably, in both the on and off states, the adjuster is at least partially transmissive to at least part of the light generated by the light source to which the adjuster is arranged. The phrase “for adjusting the direction of a light beam” especially indicates that when the adjuster is switched on, the adjuster adjusts the beam of light. When the adjuster is switched off, the light beam may pass the adjuster in an embodiment substantially unchanged.

The phrase “having an off-state and an on-state” indicates that the adjuster is configured to have at least two states, which are specified hereinbelow. In the off-state, the light beam may pass the adjuster without being substantially influenced by the adjuster. In the on-state, the beam is at least partly manipulated by the adjuster. Note that the term “on-state” may refer to a plurality of on-states. Depending upon the conditions (such as voltage) applied to the birefringent material, different on-states, and thus different manipulations of the light beam may be obtained. In this way, a user may manipulate the beam dependent upon the desires of the user. Further, herein, the “on-state” refers to a specific state that at least may be provided by the adjuster when switched on. Thus, intermediate states between the off-state and the specifically defined on-state may also be selectable for the adjuster.

The term “stack of layers” refers to substantially adjacent layers (see also further below). This does not exclude that the interfaces between two adjacent layers may have one or more curves or one or more angles. Especially, the interfaces between the solid birefringent material layer and the switchable birefringent material may comprise one or more microstructures. Hence, preferably the interfaces are non-planar. The external faces of the first and the second material layers are however preferably arranged substantially in parallel. These faces are preferably planar, whereas the layers at the interfaces with the switchable birefringent material are (thus) preferably substantially non-planar and comprise one or more microstructures.

Especially, the first interface or the second interface or both the first interface and the second interface have the shape of a lens. In a specific embodiment, the first interface or the second interface or both the first interface and the second interface have the shape of a plurality of lenses. The lenses may be directly adjacent, but there may also be a non-zero distance between the lenses. Preferably, when both the first and the second interface have the shape of a (plurality of) lens(es), the shapes of the lenses are substantially mirror images of each other.

In another embodiment, the first interface or the second interface or both the first interface and the second interface have the shape of a sawtooth. In a specific embodiment, the first interface or the second interface or both the first interface and the second interface have the shape of a plurality of sawteeth. The sawteeth may be directly adjacent, but there may also be a non-zero distance between the sawteeth. Preferably, when both the first and the second interface have the shape of a (plurality of) sawteeth, the shapes of the sawteeth are substantially mirror images of each other.

The embodiment of one or more lenses may for instance be used for imaging and/or for making collimated light diffuse. The embodiment of one or more sawteeth may for instance be used for redirection of the beam of light.

Hence, the interfaces may comprise one or more microstructures such as sawteeth or lenses, which, in an embodiment, are preferably substantially mirror images of each other. Preferably, thus, the first interface and/or the second interface have non-planar parts, such as one or more sawteeth and/or one or more lenses, which are non-planar in one dimension. Therefore, the first interface and/or the second interface may be shaped like corrugated structures, wherein the corrugations are preferably substantially mirror images of each other when both interfaces comprise microstructures.

Hence, preferably, in an embodiment the first interface or the second interface or both the first interface and the second interface have the shape of a 1D lens, especially, the first interface or the second interface or both the first interface and the second interface have the shape of a plurality of 1D lenses. In another embodiment, the first interface or the second interface or both the first interface and the second interface have the shape of a 1D sawtooth, especially the first interface or the second interface or both the first interface and the second interface have the shape of a plurality of 1D sawteeth (grating type).

One-dimensional (1D) structures may especially facilitate that a single light beam is adjusted to a single adjusted light beam. When multi-dimensional structures are applied, a plurality of adjusted light beams may be generated from a single light beam. Hence, especially the adjuster comprises two one-dimensionally structured interfaces in a common direction. This direction of the structures is herein also indicated as first direction.

The first and the second solid material layers preferably comprise solid materials that are birefringent. The term “solid birefringent material” relates to a birefringent material whose optic axis alignment is not variable, unlike the switchable birefringent material. Birefringence, or double refraction, is the decomposition of a ray of light into two rays (the ordinary ray and the extraordinary ray) when it passes through certain types of material, depending on the polarization of the light. This effect can occur only if the structure of the material is anisotropic (directionally dependent). If the material has a single axis of anisotropy or optic axis (i.e. it is uniaxial), birefringence can be formalized by assigning two different refractive indices to the material that are commonly called ordinary refractive index and extra-ordinary refractive index.

The term optic axis is known in the art and relates to a direction at a position in a uniaxial medium such that all ordinary rays passing that position have polarization that is perpendicular to it. Often, the optic axis is close to the director of the molecules in case of a liquid crystal. See further, Hecht (Optics, 4^{th} edition, E. Hecht, Addison-Wesley).

Examples of suitable materials for the first and the second material layers are for instance based on LCs such as RMM34c or RMM257 LC from Merck, that are included in a photopolymerized system. Such systems are for instance described in WO2004059565 and are known to the person skilled in the art.

In the “off-state”, for each interface the media on both sides of the interface may give rise to a refractive index that is substantially the same on both sides of the interface for unpolarized light being aligned to a normal of the stack (off-state).

The switchable (birefringent) medium at each of the two interfaces can be switched to a state called “on-state” where for the first interface the media on both sides of the interface may give rise to a refractive index that is substantially the same on both sides of the interface for light being aligned to a normal of the stack and having a polarization in a second direction being either aligned or perpendicular to the first direction, and may give rise to a refractive index that is substantially different on both sides of the interface for light being aligned to a normal of the stack and having a polarization in a direction perpendicular to the second direction, and where for the second interface the media on both sides of the interface may give rise to a refractive index that is substantially the same on both sides of the interface for light being aligned to a normal of the stack and having a polarization in a third direction being either aligned or perpendicular to the first direction, and may give rise to a refractive index that is substantially different on both sides of the interface for light being aligned to a normal of the stack and having a polarization in a direction perpendicular to the third direction.

In a specific embodiment, the stack comprises a stack of the first solid material layer, a layer of switchable birefringent material, and the second solid material layer, wherein the first optic axis and the second optic axis are perpendicular. Such an adjuster essentially consists of three layers, wherein the first and the second solid material layer sandwich the switchable birefringent material. Especially, in such an embodiment, the switchable birefringent material may comprise twisted nematic liquid crystal material or chiral nematic liquid crystal material. Further, the first optic axis and the second optic axis may be oriented in a plane of the stack.

In the off-state, the optic axis of the switchable birefringent material at the first interface is perpendicular to the optic axis of the same switchable material at the second interface. By for instance using twisted nematic liquid crystal material, a twist of substantially 90° may be imposed on the optic axis of the switchable material over the material layer.

In the on-state, the optic axis (or optic axes) of the birefringent material in the layer of switchable birefringent material changes to a state where the optic axis is perpendicular to both the optic axis of the first solid material layer and the optic axis of the second material layer. In the on-state, the optic axes within the switchable material are substantially all aligned. An advantage of this embodiment is that a relatively simple adjuster can be obtained with three layers only.

In a further specific embodiment, the stack comprises a stack of the first solid material layer, a first layer of switchable birefringent material and the first solid material layer, creating a first interface, and a second layer of switchable material and the second solid material layer, creating a second interface, wherein the first optic axis (of the first solid material) and the second optic axis (of the second solid material) are perpendicular with respect to each other.

In the off-state, the optic axes of the switchable birefringent material are perpendicular to each other, but parallel to the respective optic axes of the first and second solid material.

In the on-state, the optic axes of the switchable birefringent material in the first and second layer (of switchable birefringent material) may again be perpendicular to each other, but are switched in the sense that the optic axis of the first layer of switchable material is perpendicular to both the first optic axis of the first solid material and to the optic axis of the second layer of switchable material, and the optic axis of the second layer of switchable material is perpendicular to both the second optic axis of the second solid material and the optic axis of the first layer of switchable material. Especially, in such an embodiment, the switchable birefringent materials may comprise non-chiral nematic liquid crystal. An advantage of this over the previous embodiment is that this embodiment may provide relatively thin adjusters. It may further allow independent control of polarizations. This may further allow splitting of the beam, if desired.

In yet a further specific embodiment, the stack comprises a stack of the first solid material layer, a first layer of switchable birefringent material and the first solid material layer, creating a first interface, an intermediate layer, comprising a polarization rotator, and a second layer of switchable material and the second solid material layer, creating a second interface, wherein the first optic axis (of the first solid material) and the second optic axis (of the second solid material) are parallel to each other. This embodiment further comprises a polarization rotation element, such as a twisted nematic cell or interference stack. Further, the first optic axis and the second optic axis of the solid material layers may be oriented in a plane of the stack.

In the on-state, the optic axes of the first and second layers of switchable birefringent materials may be arranged parallel to each other and perpendicularly to the optic axes of the first and second solid (birefringent) materials. An advantage over the second specific embodiment may be that a relatively simple device may be obtained, since the adjuster in fact comprises two substantially identical cells (first layer/first solid material and second layer/second solid material), that sandwich the polarization rotator. In this embodiment, the first and second interfaces preferably do not comprise microstructures.

In summary, the invention especially provides in an embodiment a stack of two non-planar surfaces that may be arrays of micro-structures, wherein each surface is adjacent to a birefringent liquid crystal material and a solid material. At least at one non-planar surface the solid material needs to be birefringent. If the solid material is birefringent, then its optic axis extends preferably either perpendicularly to or along the beam. The switchable birefringent material, such as liquid crystal material, can be switched such that close to the interface its refractive indices that are perpendicular to the beam match the refractive indices of the solid that are also perpendicular to the beam (no refraction). The liquid crystal material may be either aligned with the beam or extends perpendicularly thereto. The switchable birefringent material, such as liquid crystal material, can be switched such that only one of its refractive indices that are perpendicular to the beam does not match the counterpart refractive index in the solid. Since there are two non-planar surfaces, there are two directions in which there is a difference in the index of refraction. If the previously mentioned two directions are not perpendicular to each other, then a (switchable) polarization element may be present to compensate for this effect.

Herein, the term “planar surface” especially refers to the surface (especially the external face(s) of the first and second material layers) that is flat and the normal of which is aligned with the incoming beam. Herein, the term “non-planar surface” especially refers to the surface that may preferably not be flat and that is not aligned (everywhere) with the incoming beam (provided that the adjuster is arranged to a light source). Further, in the “off state” the outgoing beam is approximately the same as the incoming beam, and in the “on-state” the outgoing beam is redirected/adjusted.

As is known in the art, for alignment of liquid crystals one may use standard polyimide layers that are rubbed for orienting the LC close to the surface. Electric fields can be used for imposing a second orientation of the LC. For generating electric fields, transparent indium tin oxide (ITO) electrodes may be applied. Hence, the term “stack of layers” refers to substantially adjacent layers where between two substantially adjacent layers also an ITO layer and/or a polyimide layer are present. Herein, the adjuster is especially described with reference to the three or more layers that are essential for the adjuster, i.e. the first solid material layer, the second solid material layer and one or more layers of switchable birefringent material.

The adjuster as described herein may be applied to any type of light source arranged to generate a light beam (when switched on). Hence, the invention also provides an optical device comprising a light source, configured to generate a beam of light, and the adjuster for adjusting the direction of a light beam. The optical device may be arranged to generate a single beam of light, but may also be configured to generate a plurality of light beams. In a specific embodiment, the optical device comprises a plurality of light sources configured to generate a plurality of light beams.

A specific embodiment of optical devices will, non-limitingly, be mentioned here below.

In an embodiment, the optical device comprises a display device comprising a plurality of pixels as light sources, wherein the adjuster is configured to adjust the directions of the plurality of light beams. The plurality of pixels generate the plurality of light beams, which may be manipulated by the adjuster. In a specific embodiment, the optical device comprises a plurality of adjusters.

In another embodiment, the optical device is an illumination device. Such an illumination device may be a lamp, especially a substantially point source lamp, such as a spotlight. Hence, in an embodiment, the optical device comprises a spotlight as a light source. In another embodiment, the optical device comprises a laser as a light source.

Especially, the light source is configured to generate a light beam with an opening angle selected in the range of 2-20°, such as preferably 2-10°, or even smaller. The light beam may for instance be the beam of a spotlight or of a laser.

The light source may comprise any light source, such as a small incandescent lamp or a fiber tip or fiber irregularity (arranged to let light escape from the fiber; which embodiment has the advantage that it is relatively cheap), but may especially comprise a LED (light emitting diode) (as a light source). A specific advantage of using LEDs is that they are relatively small and may therefore allow arrangement of a large number of LEDs. Another specific advantage of using LEDs is that they may provide relatively narrow beams, allowing an accurate definition of the illumination profile generated by the lighting system. The term LED may refer to OLEDs, but especially refers to solid state lighting. Unless indicated otherwise, the term LED herein further refers to solid state LEDs. In an embodiment, the light source comprises at least one light-emitting diode (LED). Solid state LEDs as light source(s) are especially desired because of their small dimensions, low weight and narrow beams

The above described embodiments are often described in relation to a light source or an optical device comprising a light source. The adapter is arranged to such a light source, intercepting at least part of the light source. In such embodiments, the light source and adjuster are in general close to each other. However, the adjuster may also be applied to adjust the beam of a remote source, for instance to adjust light to be detected by a sensor, such as a CCD camera. For instance, the adjuster may be used to sweep a certain area. Therefore, in a specific embodiment, the invention also provides an optical device comprising an optical sensor (configured to detect light), and the adjuster (as described herein), for adjusting the direction of a light beam in the direction of the sensor. Here, the embodiment of the optical device is configured to detect light (with the optical sensor). Especially, the optical device may comprise a CCD camera and the sensor may comprise a CCD array.

Unless indicated otherwise, and where applicable and technically feasible, the phrase “selected from the group consisting of a number of elements may also refer to a combination of two or more of the enumerated elements. Terms like “below”, “above”, “top”, and “bottom” relate to positions or arrangements of items which would be obtained when the lighting system is arranged substantially flat to, particularly below, a substantially horizontal surface, with the lighting system bottom face being substantially parallel to the substantially horizontal surface and facing away from the ceiling into the room. However, this does not exclude the use of the lighting system in other arrangements, such as against a wall, or in other (e.g. vertical) arrangements.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts some principles of the invention;

FIGS. 2a-2b schematically depict an embodiment of the adjuster in the “off” and “on” state;

FIGS. 3a-3b schematically depict another embodiment of the adjuster in the “off” and “on” state;

FIGS. 4a-4b schematically depict yet another embodiment of the adjuster in the “off” and “on” state;

FIGS. 5a-5b schematically depict embodiments of microstructured interfaces; and

FIGS. 6a-6c schematically depict embodiments of optical devices comprising the adjuster according to the invention.

### DETAILED DESCRIPTION

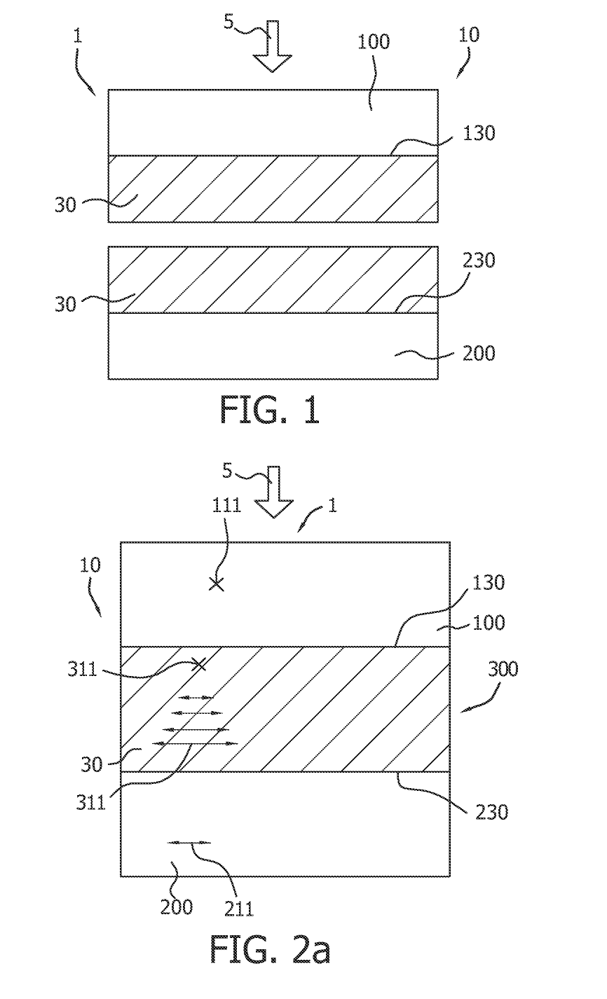

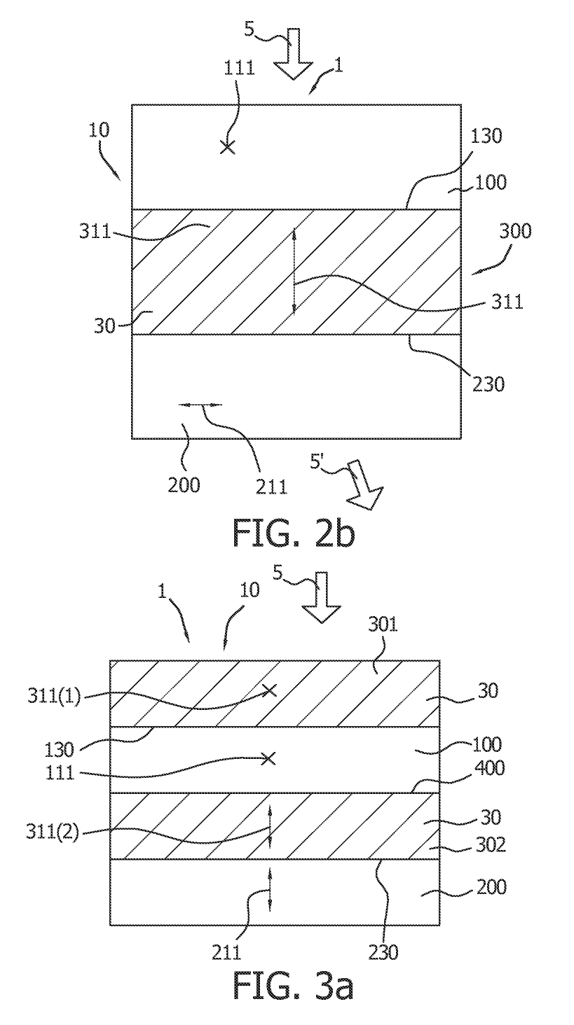

FIG. 1 schematically depicts an adjuster 1 for adjusting the direction of a light beam 5. The adjuster 1 comprises a stack 10 of layers. The stack 10 comprises a first solid material layer 100 having a first optic axis (not depicted, see FIGS. 2a-4b), a second solid material layer 200 having a second optic axis (not depicted, see FIGS. 2a-4b), and switchable birefringent material 30. The switchable birefringent material may be arranged in a single layer or in separate layers (see below).

For the sake of understanding, polyimide layers and electrode layers such as ITO layers are not drawn in the Figures. Those features are known to the person skilled in the art. The term “adjacent” herein may thus in some embodiments mean that between at least part of adjacent items, for instance a polyimide layer and/or (transparent) ITO layer is present.

The stack further comprises a first interface 130 between the first solid material layer 100 and birefringent material 30 and a second interface 230 between the second solid material layer 200 and birefringent material 30.

The materials of the first material layer 100 and the second material layer 200 as well as the switchable birefringent material are selected and configured such that (a) in the off-state, the birefringent material 30 at the first interface 130 has an optic axis parallel to the first optic axis and the birefringent material 30 at the second interface 230 has an optic axis parallel to the second optic axis; and (2) in the on-state, the birefringent material 30 at the first interface 130 has an optic axis perpendicular to the first optic axis and the birefringent material 30 at the second interface 230 has an optic axis perpendicular to the second optic axis.

The first and the second solid material layers 100,200 preferably comprise solid materials that are birefringent. The switchable birefringent material is preferably a liquid crystal material, such as twisted nematic liquid crystal or chiral nematic liquid crystal material.

Especially, the interfaces 130,230 may comprise one or more microstructures (see below). The external faces of the first and the second material layers are however preferably arranged substantially parallel to each other. These faces are preferably planar, whereas the switchable birefringent material-comprising layers at the interfaces 130,230 are (thus) preferably substantially non-planar and comprise one or more microstructures (see below).

In a specific embodiment, depicted in FIGS. 2a-2b (“off-state” and “on-state”, respectively), the stack 10 comprises a stack of the first solid material layer 100, a layer 300 of switchable birefringent material 30, and the second solid material layer 200. The first optic axis, indicated with reference 111, and the second optic axis, indicated with reference 211, are chosen to be perpendicular with respect to each other. Such an adjuster 1 essentially consists of three layers, wherein the first and the second solid material layers sandwich the switchable birefringent material. Especially, in such an embodiment, the switchable birefringent material 30 comprises twisted nematic liquid crystal material, such as TL213 from Merck.

In the off-state, the optic axis of the switchable birefringent material, here rather optic axes (referenced 311) because especially chiral nematic material is applied as switchable birefringent material at the respective interfaces 130 and 230, are aligned parallel with the optic axes 111 and 211 (of the solid materials at the other side of the respective interfaces). Hence, at the interfaces 130,230 the optic axes are aligned parallel to each other at both sides of the interfaces. The optic axes of the birefringent material layer may rotate through 90° to obtain the desired configuration of the optic axes in relation to the first and second optic axes 111,211 of the first and the second solid materials 100,200.

The layer thickness of the switchable birefringent layer in this embodiment, wherein the birefringent material may comprise twisted nematic LC, may be in the range of about 40-100 μm, such as about 50 μm. Such a thickness may be enough to create a 90° rotation.

When the adjuster 1 is switched on, the alignment of the optic axis of the switchable birefringent material 30 changes, and aligns perpendicularly to both the optic axes of the first and the second material layers. Here, the optic axis 311 of the birefringent material is aligned, substantially throughout the material, perpendicularly to the optic axes 111,211 of the first and second material layers.

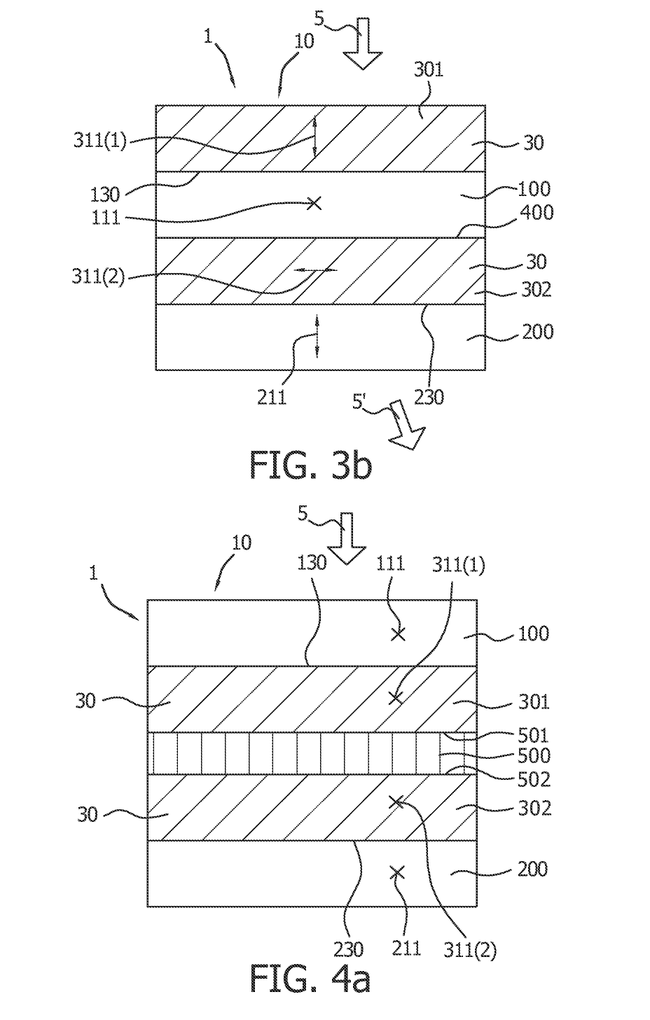

In a further specific embodiment, depicted in FIGS. 3a-3b (“off-state” and “on-state”, respectively), the stack 10 comprises a stack 10 of:

a first layer 301 of switchable birefringent material 30;

first solid material layer 100;

a second layer 302 of switchable material 30; and

the second solid material layer 200.

The first layer 301 of switchable birefringent material 30 and the first solid material layer 100 create first interface 130. The second layer 302 of switchable material 30 and the second solid material layer 200 create second interface 230. In fact, this stack 10 comprises 2 cells, i.e. the first layer 301 and the first solid material 100, and the second layer 302 and the second solid material 200. These two cells may be arranged adjacent one another, i.e. first material 100 and second layer 302 create a further interface 400. This further interface 400 is preferably planar. The optic axes in the respective first and second layers 301,302 of switchable birefringent material 30 are indicated with references 311(1) and 311(2), respectively.

Here, the first optic axis 111 and the second optic axis 211 in this embodiment are perpendicular with respect to each other. The optic axis 311(1) (substantially throughout the material of the first layer 301 of switchable birefringent material 30) of the first layer 301 is parallel with the first optic axis 111. The optic axis 311(2) (substantially throughout the material of the second layer 302 of switchable birefringent material 30) of the second layer 302 is parallel with the second optic axis 211.

In the off-state, the optic axes 311(1) and 311(2) at the respective interfaces 130 and 230 are thus aligned in parallel with the optic axes 111 and 211 of the first solid material layer 100 and the second solid material layer 200, respectively. When the adjuster 1 is switched on, the alignment of the optic axes of the switchable birefringent material 30 changes and aligns perpendicularly to both the optic axes of the first and the second material layers, and perpendicularly to each other. Referring to FIG. 3b, the optic axis 311(1) of the first layer 301 of switchable birefringent material 30 is perpendicular to the optic axis 111 of the first solid material layer 100 and perpendicular to the optic axis 311(2) of the second layer 302 of switchable birefringent material 30. The optic axis 311(2) of the second layer 302 of switchable birefringent material 30 is perpendicular to the optic axis 211 of the second solid material layer 200 and perpendicular to the optic axis 311(1) of the first layer 301 of switchable birefringent material 30.

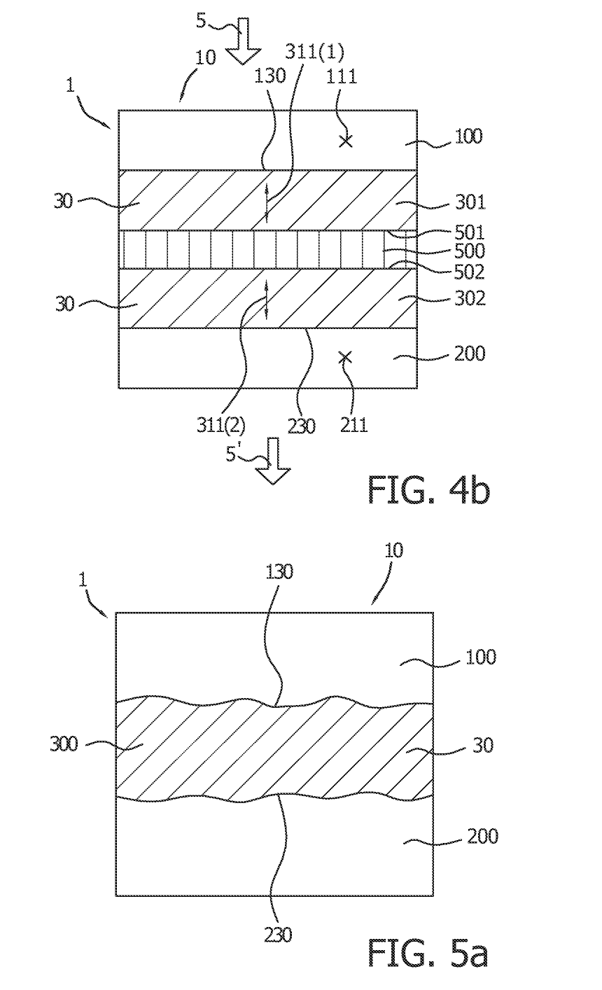

In yet a further specific embodiment, depicted in FIGS. 4a-4b (“off-state” and “on-state”, respectively), the stack 10 comprises a stack of

the first solid material layer 100;

a first layer 301 of switchable birefringent material 30;

an intermediate layer 500 comprising a polarization rotator, such as a twisted nematic cell;

a second layer 302 of switchable material 30; and

the second solid material layer 200.

The first layer 301 of switchable birefringent material 30 and the first solid material layer 100 create first interface 130. The second layer 302 of switchable material 30 and the second solid material layer 200 create second interface 230.

Here, again, two cells are provided, which cells both comprise a switchable birefringent material and a (birefringent) solid material layer. The optic axes (111/311(1) and 211/311(2)) within the individual cells (100/301 and 200/302, respectively) are aligned in parallel with each other. Further, all optic axes may be aligned in parallel with one another in the off state.

Between the two cells, the polarization rotator 500 is arranged. The cells may sandwich the polarization rotator 500. In a specific embodiment, the first layer 301 of switchable birefringent material 30 creates an interface 501 with the polarization rotator 500. In a further specific embodiment, the second layer 302 of switchable birefringent material 30 creates an interface 502 with the polarization rotator 500.

In the on-state, the direction of the optic axes of the switchable birefringent material 30 changes for both the first layer 301 and the second layer 302. The optic axes 311(1) and 311(2) swap to a perpendicular state relative to the optic axes 111,211 of the solid material layers 100, 200, respectively. Further, they swap to a state where they are mutually parallel. Further, they may swap to a state where they are substantially perpendicular to the external face (i.e. substantially parallel to a normal to the stack 1).

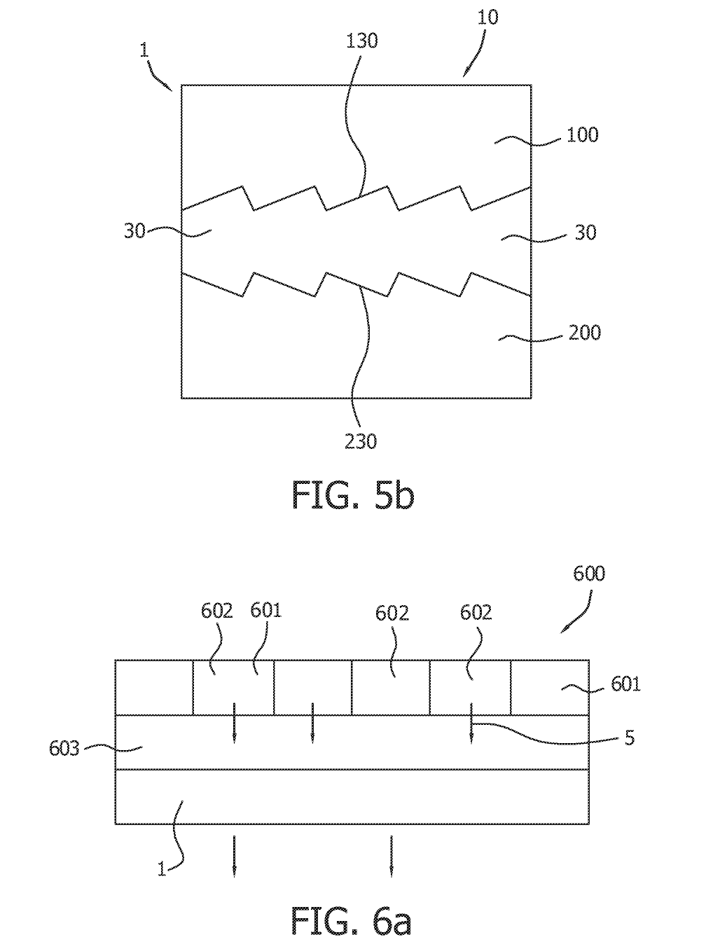

FIGS. 5a-5b non-limitingly depict some embodiments of microstructures on the interfaces 130 and 230. In FIG. 5a, these microstructures are lens-shaped, and in FIG. 5b sawtooth-shaped. Note that, preferably, the microstructures are one-dimensional. Hence, FIGS. 5a/5b may schematically depict cross-sections of embodiments of stack 10.

In some of the embodiments (see for instance FIGS. 1-3), the change in refractive index for the deflected part of the beam passing the first interface in the on-state is opposite in sign with respect to the change of the refractive index of the deflected part of the beam passing the second interface. If the same action is demanded at each interface (redirection in a certain direction or focusing, for instance), then for small differences in index, the shapes of the microstructures may substantially be mirror images. One can, however, induce small differences for obtaining an optimal effect. For the embodiment of FIGS. 4a-4b, preferably the interfaces do not comprise microstructures.

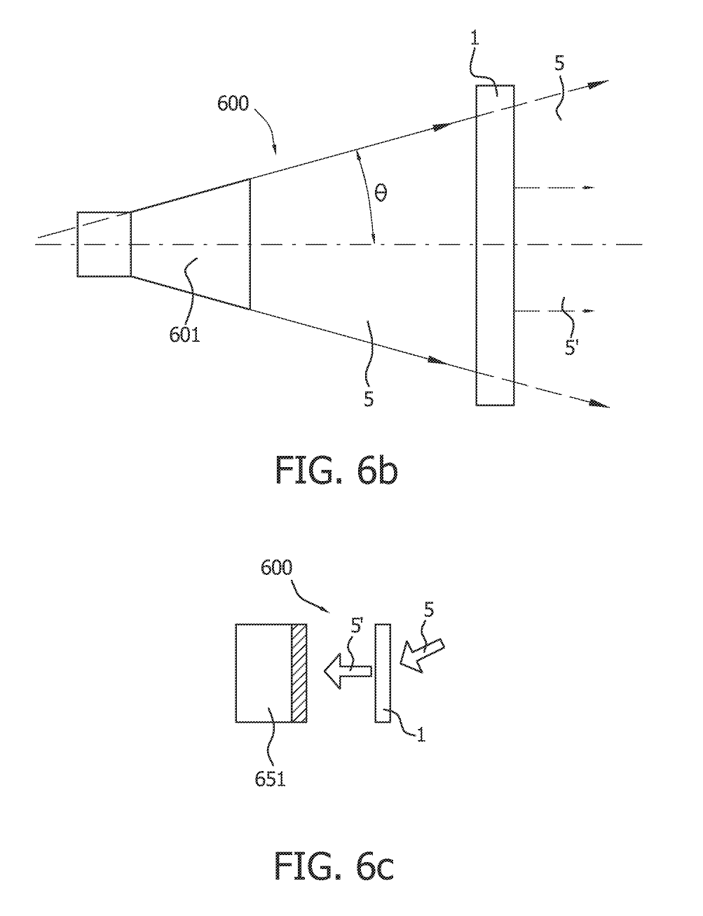

FIGS. 6a-6b schematically depict embodiments of an optical device 600 comprising the adjuster 1.

The optical device 600 comprises a light source 601 configured to generate a beam of light 5. The optical device 600 further comprises the adjuster 1 for adjusting the direction of a light beam 5. The optical device 600 may be arranged to generate a single beam of light, but may also be configured to generate a plurality of light beams 5.

Here, by way of example, the optical device 600 of FIG. 6a comprises a display device comprising a plurality of pixels 602 as light sources 601. The adjuster 1 is configured to adjust the directions of the plurality of light beams 5. The plurality of pixels 602 generate the plurality of light beams 5, which may be manipulated by the adjuster 1. In a specific embodiment, the optical device 600 may optionally comprise a plurality of adjusters 1.

In another embodiment, the optical device 600 is an illumination device, see FIG. 6b. Such an illumination device may be a lamp, especially a substantially point source lamp, such as a spotlight. Hence, in an embodiment, the optical device 600 comprises a spotlight as light source 601. Especially, the light source 601 is configured to generate a light beam 5 with an opening angle (2*θ) selected in the range of 2-20°, such as preferably 2-10°. When the adjuster 1 is switched on, the adjusted beam (or adjusted light beam), downstream of the adjuster 1, is indicated with reference 5′.

FIG. 6c schematically depicts an embodiment of the optical device 600, wherein the device is arranged to detect light. The optical device 600 comprises an optical sensor 651, such as a CCD array, and the adjuster 1 as described herein. The adjuster may be used to redirect light beams 5 in the direction of the optical sensor. For instance, in this way one may scan or sweep areas.

Hence, the invention provides an adjuster for adjusting the direction of a light beam 5. The adjuster 1 has an off-state and an on-state and comprises a stack 10 of layers. The stack 10 comprises a first solid material layer 100 having a first optic axis 111, a second solid material layer 200 having a second optic axis 211, and switchable birefringent material 30. Further, the stack includes a first interface 130 between the first solid material layer 100 and birefringent material 30, and a second interface 230 between the second solid material layer 200 and birefringent material 30. In the off-state, the birefringent material 30 at the first interface 130 is configured to have an optic axis parallel to the first optic axis 111 and the birefringent material 30 at the second interface 230 is configured to have an optic axis parallel to the second optic axis 211. In the on-state, the birefringent material 30 at the first interface 130 is configured to have an optic axis perpendicular to the first optic axis 111 and the birefringent material 30 at the second interface 230 is configured to have an optic axis perpendicular to the second optic axis 211. This device may be used to redirect light beams, for instance for spotlights, display devices or optical sensors.

In the drawings, less relevant features like electrical cables, etc. have not (all) been drawn for the sake of clarity.

The term “substantially” herein, such as in “substantially flat” or in “substantially consists”, etc., will be understood by the person skilled in the art. In embodiments, the adjective substantially may be removed. Where applicable, the term “substantially” may also include embodiments with “entirely”, “completely”, “all”, etc. Where applicable, the term “substantially” may also relate to 90% or higher, such as 95% or higher, especially 99% or higher, including 100%. The term “comprise” includes also embodiments wherein the term “comprises” means “consists of”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than those described or illustrated herein.

The devices employed herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The term “and/or” includes any and all combinations of one or more of the associated listed items. The article “a” or “an” preceding an element does not exclude the presence of a plurality of such elements. The article “the” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An adjuster for adjusting the direction of a light beam, the adjuster having an off-state and an on-state and comprising a stack of layers, wherein
the stack comprises a first solid material layer having a first optic axis, a second solid material layer having a second optic axis, and switchable birefringent material;
a first interface between the first solid material layer and birefringent material and a second interface between the second solid material layer and birefringent material; wherein
in the off-state, the birefringent material at the first interface is configured to have an optic axis parallel to the first optic axis and the birefringent material at the second interface is configured to have an optic axis parallel to the second optic axis; and
in the on-state, the birefringent material at the first interface is configured to have an optic axis perpendicular to the first optic axis and the birefringent material at the second interface is configured to have an optic axis perpendicular to the second optic axis.

2. The adjuster according to claim 1, wherein the stack comprises a stack of the first solid material layer, a layer of switchable birefringent material, and the second solid material layer, wherein the first optic axis and the second optic axis are perpendicular with respect to each other; and wherein the first optic axis and the second optic axis are oriented in a plane of the stack.

3. The adjuster according to claim 2, wherein the switchable birefringent material comprises twisted nematic liquid crystal or chiral nematic liquid crystal material.

4. The adjuster according to claim 1, wherein the stack comprises a stack of the first solid material layer, a first layer of switchable birefringent material and the first solid material layer, creating first interface, and a second layer of switchable material and the second solid material layer, creating second interface, wherein the first optic axis and the second optic axis are perpendicular with respect to each other.

5. The adjuster according to claim 1, wherein the stack comprises a stack of the first solid material layer, a first layer of switchable birefringent material and the first solid material layer, creating first interface, an intermediate layer, comprising a polarization rotator, and a second layer of switchable material and the second solid material layer, creating second interface, wherein the first optic axis and the second optic axis are parallel to one another.

6. The adjuster according to claim 1, wherein the first interface or the second interface or both the first interface and the second interface have the shape of a lens.

7. The adjuster according to claim 1, wherein the first interface or the second interface or both the first interface and the second interface have the shape of a sawtooth.

8. An optical device comprising a light source, configured to generate a beam of light, and the adjuster according to claim 1, for adjusting the direction of a light beam.

9. The optical device according to claim 8, configured to generate a plurality of light beams.

10. The optical device according to claim 9, wherein the optical device comprises a display device comprising a plurality of pixels as light sources, wherein the adjuster is configured to adjust the directions of the plurality of light beams.

11. The optical device according to claim 9, wherein the optical device is an illumination device.

12. The optical device according to claim 9, wherein the optical device comprises a spotlight as a light source, wherein the light source is configured to generate a light beam with an opening angle selected in the range of 2-20°.

13. The optical device, comprising an optical sensor, and the adjuster according to claim 1, for adjusting the direction of a light beam in the direction of the sensor.

14. The optical device according to claim 13, wherein the optical device comprises a CCD camera and the optical sensor comprises a CCD array.

15. The optical device according to claim 13, comprising a plurality of adjusters.
